(19) United States
(12) Patent Application Publication
(10) Pub. No.: US 2024/0222771 A1
(43) Pub. Date: Jul. 4, 2024

(54) BATTERY PACK HAVING IMPROVED IMPACT RESISTANCE

(71) Applicant: LG ENERGY SOLUTION, LTD., Seoul (KR)

(72) Inventors: Dong Won YOO, Daejeon (KR); Young Su SON, Daejeon (KR); Young Kyu LEE, Daejeon (KR); Seong Hwan YANG, Daejeon (KR); Mun Jun BAE, Daejeon (KR)

(73) Assignee: LG ENERGY SOLUTION, LTD., Seoul (KR)

(21) Appl. No.: 18/287,173

(22) PCT Filed: Nov. 3, 2022
(86) PCT No.: PCT/KR22/17077

§ 371 Date: Oct. 16, 2023

(30) Foreign Application Priority Data
Nov. 16, 2021 (KR) 10-2021-0157889

(51) Int. Cl. H01M 50/242; H01M 50/202; H01M 50/213; H01M 50/244

(52) U.S. Cl. CPC H01M 50/242; H01M 50/202; H01M 50/244; H01M 50/213

(57) ABSTRACT

A battery pack includes a lower case defining a first space having a predetermined size; an upper case at an upper part of the lower case to be fastened to the lower case, the upper case defining a second space; at least one module frame in the first space of the lower case and the second space of the upper case, the module frame defining a battery cell receiving recess; and a battery cell in the battery cell receiving recess. An impact attenuation member configured to protect the module frame from external impact is disposed between an outer surface of the module frame and an inner surface of the lower case.

### TECHNICAL FIELD

This application claims the benefit of priority to Korean Patent Application No. 2021-0157889 filed on Nov. 16, 2021, the disclosure of which is incorporated herein by reference in its entirety.

The present invention relates to a battery pack having improved impact resistance, and more particularly to a battery pack having improved impact resistance configured such that a battery module is protected from internal vibration or impact and the battery pack is easily assembled.

### BACKGROUND ART

With recent development of alternative energies due to air pollution and energy depletion caused as the result of use of fossil fuels, demand for secondary batteries capable of storing electrical energy that is produced has increased. Secondary batteries, which are capable of being charged and discharged, are widely used in various fields, such as mobile devices, electric vehicles, hybrid electric vehicles, and industrial robots.

Required capacities of secondary batteries used as energy sources of various kinds of electronic devices inevitably used in modern society have been increased due to an increase in usage of mobile devices, increasing complexity of the mobile devices, and development of electric vehicles. In order to satisfy demand of users, a plurality of battery cells is disposed in a small-sized device, whereas a battery module including a plurality of battery cells electrically connected to each other or a battery pack including a plurality of battery modules is used in a vehicle.

Meanwhile, a battery pack includes a battery pack case in order to package battery modules, and the battery modules are fixed in the battery pack case in order to prevent vibration or impact. In a conventional battery pack, the battery modules are generally fixed in the battery pack case through a separate structure, such as a bolt and nut.

However, it is impossible to completely protect the battery modules from external impact using only a known fastening means, such as a bolt and nut, and when a large number of bolts and nuts are used, the size of the battery pack is increased, since a fastening space is necessary.

### PRIOR ART DOCUMENT

(Patent Document 1) Korean Registered Patent Publication No. 2167632 (published on Oct. 19, 2020)

### DISCLOSURE

### Technical Problem

The present invention has been made in view of the above problems, and it is an object of the present invention to provide a battery pack having improved impact resistance configured such that an impact attenuation member is provided in a space between a battery module and the battery pack.

It is another object of the present invention to provide a battery pack having improved impact resistance configured to have a structure in which the size of the battery pack is not increased and the battery pack is easily assembled.

### Technical Solution

In order to accomplish the above objects, a battery pack according to the present invention includes a lower case (100) provided with a space having a predetermined size, an upper case (200) located at an upper part of the lower case (100) so as to be fastened to the lower case, at least one module frame (300) received in the space of the lower case (100) and a space of the upper case (200), the module frame being provided with a battery cell receiving recess (310), and a battery cell received in the battery cell receiving recess (310), wherein an impact attenuation member configured to protect the module frame (300) from external impact is provided between an outer surface of the module frame (300) and an inner surface of the lower case (100).

Also, in the battery pack according to the present invention, the impact attenuation member may be a first stopper (400), and the first stopper (400) may include a first columnar pressing portion (410) brought into tight contact with the outer surface of the module frame (300) and a pair of wings (420) extending from opposite sides of the first pressing portion (410) by a predetermined length.

Also, in the battery pack according to the present invention, a first receiving portion (110) configured to fix the first stopper (400) may be provided in a side wall of the lower case (100), and the first receiving portion (110) may include a receiving recess (111) configured to encompass a rear surface and a side surface of each wing (420) such that the wing is seated and fixed, a horizontal support projection (112) configured to support a bottom surface of the wing (420), a pair of vertical support projections (113) configured to support a part of a front surface of the wing (420), and an opening (114) provided between the pair of vertical support projections (113) such that the first pressing portion (410) protrudes forwards by a predetermined length.

Also, in the battery pack according to the present invention, a front middle part of the first pressing portion (410) may protrude farther forwards than front upper and lower parts of the first pressing portion in a height direction.

Also, in the battery pack according to the present invention, a rear middle part of the first pressing portion (410) may protrude farther rearwards than rear upper and lower parts of the first pressing portion in the height direction.

Also, in the battery pack according to the present invention, the impact attenuation member may be a second stopper (500), and the second stopper (500) may include a second columnar pressing portion (510) having one side brought into tight contact with the outer surface of the module frame (300) and the other side brought into tight contact with the inner surface of the lower case (100), a head portion (520) having one surface brought into tight contact with an outer surface of the lower case (100), and a connection portion (530) configured to connect the second pressing portion (510) and the head portion (520) to each other.

Also, in the battery pack according to the present invention, a second receiving portion (120) configured to fix the second stopper (500) may be provided in a side wall of the lower case (100), and the second receiving portion (120) may include a through-hole (121) configured to allow the connection portion (530) to be located therein, an outer support projection (122) formed at the outer surface of the lower case (100), the outer support projection being configured to support the head portion (520), and an inner support projection (123) formed at the inner surface of the lower case (100), the inner support projection being configured to support a part of the second pressing portion (510).

Also, in the battery pack according to the present invention, each of the second pressing portion (510), the head portion (520), and the connection portion (530) may be cylindrical, the diameter of the connection portion (530) may be less than the diameter of each of the second pressing portion (510) and the head portion (520), and the diameter of the through-hole (121) may be less than the diameter of each of the second pressing portion (510) and the head portion (520).

Also, in the battery pack according to the present invention, the diameter of the head portion (520) may be greater than the diameter of the second pressing portion (510).

Also, in the battery pack according to the present invention, a depressed portion (511) may be formed in one end of the second pressing portion (510) so as to form a predetermined space.

In addition, the present invention provides a device having the battery pack mounted therein.

### Advantageous Effects

As is apparent from the above description, a battery pack having improved impact resistance according to the present invention has an advantage in that a first stopper constituted by a first columnar pressing portion made of an elastic material and a pair of wings is interposed between an outer surface of a module frame and an inner surface of a case, whereby it is possible to protect a battery module from external impact or vibration.

In addition, the battery pack having improved impact resistance according to the present invention has an advantage in that a second stopper constituted by a second columnar pressing portion made of an elastic material, a head portion, and a connection portion is interposed between the outer surface of the module frame and the inner surface of the case, whereby it is possible to protect the battery module from external impact or vibration.

In addition, the battery pack having improved impact resistance according to the present invention has a merit in that a receiving portion integrally formed with the case is provided, whereby it is possible to stably receive and fix the first stopper and the second stopper.

Furthermore, the battery pack having improved impact resistance according to the present invention has an advantage in that the first stopper and the second stopper are easily mounted in the case, whereby it is possible to achieve easy assembly.

### DESCRIPTION OF DRAWINGS

FIG. 1 is a perspective view of a battery pack according to a preferred embodiment of the present invention.

FIG. 2 is a plan view showing the interior of the battery pack shown in FIG. 1.

FIG. 3 is an enlarged view showing part A of FIG. 2.

FIG. 4 is a perspective view of a first stopper mounted in the battery pack according to the preferred embodiment of the present invention.

FIG. 5 is an enlarged view of a first receiving portion configured to receive the first stopper in part A of FIG. 3.

FIG. 6 is a perspective view of a module frame mounted in the battery pack according to the preferred embodiment of the present invention.

FIG. 7 is an enlarged view showing part B of FIG. 2.

FIG. 8 is a front perspective view of a second stopper mounted in the battery pack according to the preferred embodiment of the present invention.

FIG. 9 is a bottom perspective view of the second stopper shown in FIG. 8.

FIG. 10 is a perspective view of a second receiving portion in which the second stopper is mounted when viewed from the outside of a lower case.

FIG. 11 is a perspective view of the second receiving portion in which the second stopper is mounted when viewed from the inside of the lower case.

FIG. 12 is a perspective view illustrating the state in which the second stopper is mounted to part B of FIG. 2.

FIG. 13 is a perspective view of the second stopper before being mounted in the battery pack when viewed from below.

### BEST MODE

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is said to be connected to another part in the entire specification, not only may the one part be directly connected to the other part, but also, the one part may be indirectly connected to the other part via a further part. In addition, that a certain element is included does not mean that other elements are excluded, but means that such elements may be further included unless mentioned otherwise.

Hereinafter, a battery pack having an impact attenuation member according to the present invention will be described with reference to the accompanying drawings.

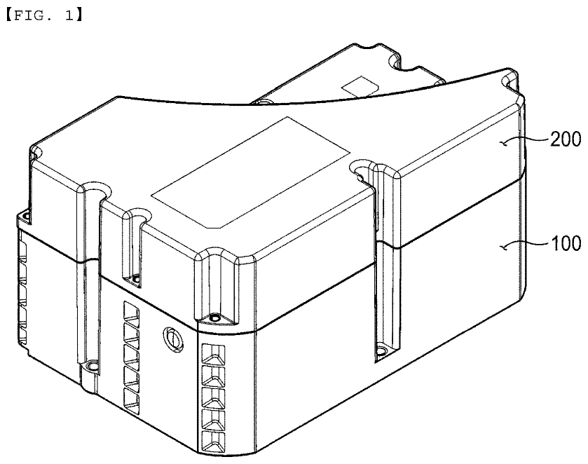

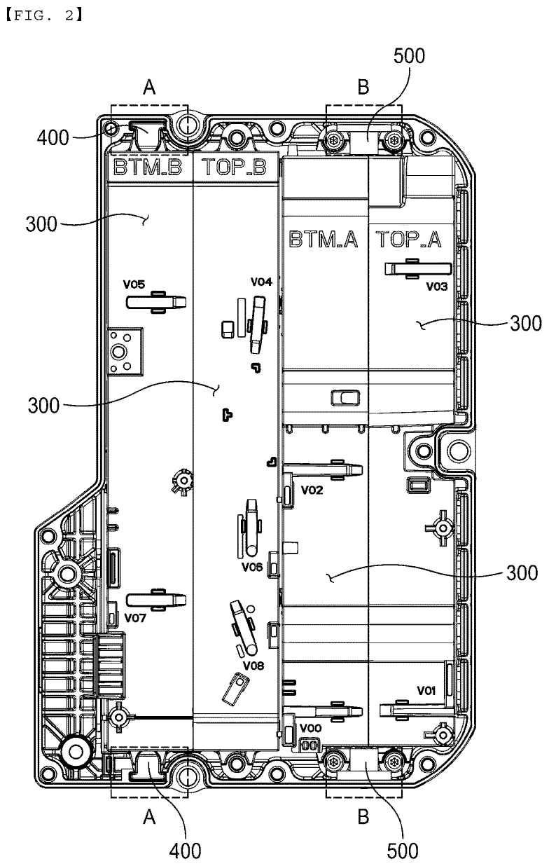

FIG. 1 is a perspective view of a battery pack according to a preferred embodiment of the present invention, and FIG. 2 is a plan view showing the interior of the battery pack shown in FIG. 1.

Referring to FIGS. 1 and 2, the battery pack according to the present invention includes a lower case 100, an upper case 200, a module frame 300, and a first stopper 400 and a second stopper 500 constituting an impact attenuation member.

Although the lower case 100 has a structure in which the lower case is surrounded by predetermined walls in the drawings, the present invention is not limited thereto, and the lower case may be replaced with a cover having no separate space.

In addition, although four module frames 300 are shown as being mounted, which, however, is merely an example, the number of the module frames may be increased or decreased.

In addition, although a pair of first stoppers 400 are shown as being located at the front and the rear (an upper part and a lower part in the drawings) of the leftmost module frame 300 and a pair of second stoppers 500 are shown as being located at the front and the rear of the rightmost module frame 300, it is obvious that a pair of stoppers may be located at the front and the rear of each module frame.

In addition, only the first stoppers 400 may be mounted at the front and the rear of each module frame 300, or the second stoppers 500 may be mounted at the front and the rear of each module frame 300.

Furthermore, stoppers may be further provided at sides of module frames 300 disposed adjacent to side walls of the lower case 100, in addition to the front and the rear thereof.

When the battery pack is abnormal, for example when external impact is applied to the battery pack or when the battery pack drops, the first stopper 400 and the second stopper 500 attenuate impact to protect a battery module having a battery cell received therein.

The lower case 100 has a space sufficient to receive the module frame 300, and is surrounded by side walls such that the battery module is primarily protected from external impact. The upper case 200 may be seated on the lower case 100, and the cases may be fixed to each other via a known fastening means, such as a long bolt.

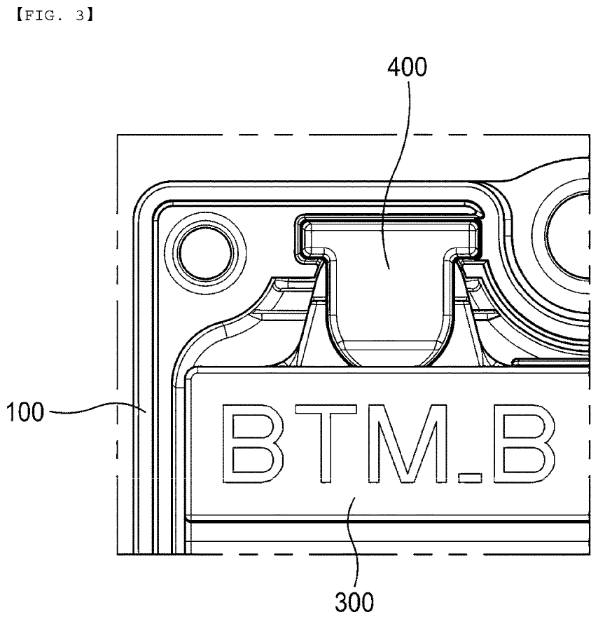

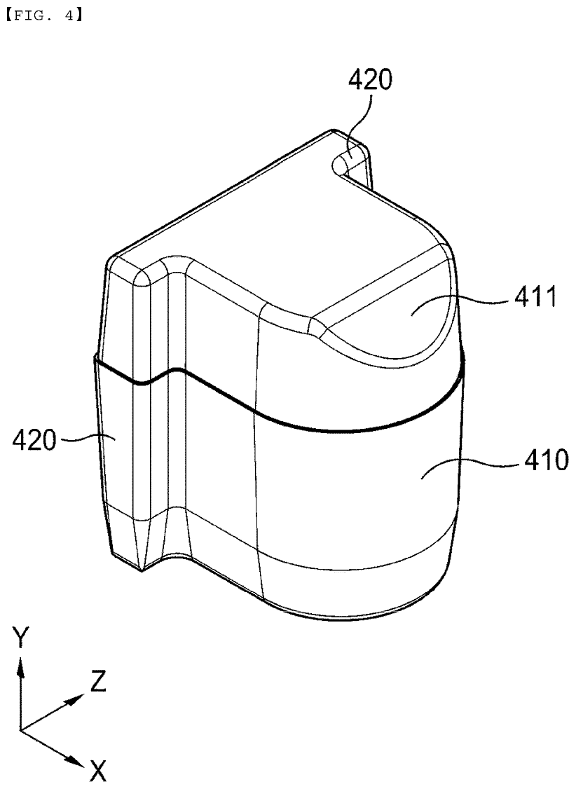

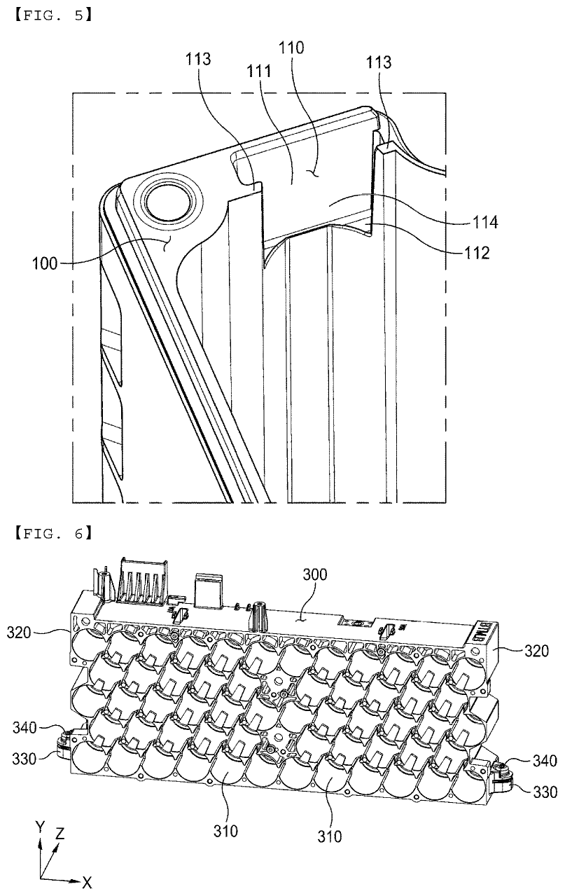

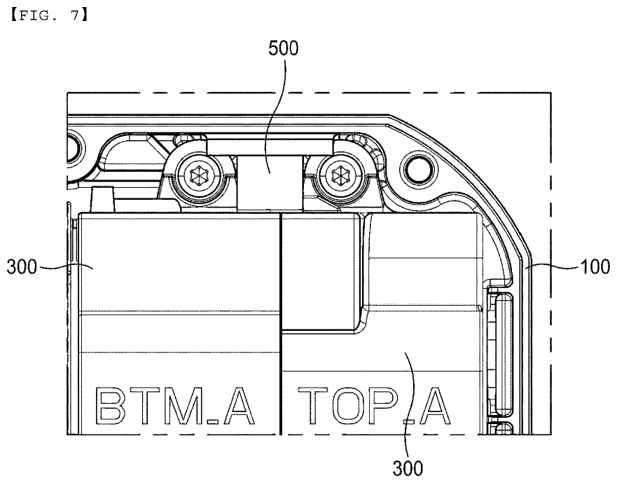

FIG. 3 is an enlarged view showing part A of FIG. 2, FIG. 4 is a perspective view of the first stopper mounted in the battery pack according to the preferred embodiment of the present invention, FIG. 5 is an enlarged view of a first receiving portion configured to receive the first stopper in part A of FIG. 3, and FIG. 6 is a perspective view of the module frame mounted in the battery pack according to the preferred embodiment of the present invention.

The first stopper of the present invention will be described in detail with reference to FIGS. 3 to 6.

The first stopper 400 includes a first columnar pressing portion 410 brought into tight contact with a pressure surface 320 of the module frame 300, which is an outer surface, and a pair of wings 420 extending from opposite sides of the first pressing portion 410 by a predetermined length.

Specifically, when viewed from above, the first stopper 400 has a shape similar to an approximately “T” shape. Here, it is preferable for the front part of the first pressing portion 410, i.e. the part of the first pressing portion brought into tight contact with the pressure surface 320 of the module frame 300, to somewhat protrude toward the front (X-axis direction) in order to increase pressing force, e.g. to be somewhat rounded in a circumferential direction.

Meanwhile, it is preferable for front and rear middle parts of the first pressing portion 410 to slightly protrude in a height direction (Y-axis direction). Specifically, the front middle part of the first pressing portion 410 protrudes farther forwards than front upper and lower parts thereof, and the rear middle part of the first pressing portion protrudes farther rearwards than rear upper and lower parts thereof.

The reason for this is that it is possible to fix the module frame 300 in a tight contact state with stronger force, as previously described, and to prevent separation of the first stopper 400 from a first receiving portion provided in the side wall of the lower case 100, a description of which will follow, after the first stopper is received in the first receiving portion.

In particular, since the front and rear middle parts of the first pressing portion 410 protrude slightly more than the front and rear lower parts thereof, it is possible to easily mount the first stopper in the first receiving portion provided in the side wall of the lower case 100.

Meanwhile, it is preferable for a first inclined surface 411 slightly inclined forwards to be provided on an upper surface of the first pressing portion 410. The reason for this is that it is possible to easily insert the module frame 300 to be mounted into the lower case 100 along the first inclined surface 411.

The first receiving portion 110 configured to fix the first stopper 400 is formed in the side wall of the lower case 100, i.e. the part of the lower case that faces the pressure surface 320 of the module frame 300.

Specifically, the first receiving portion 110 is constituted by a receiving recess 111, a horizontal support projection 112, a pair of vertical support projections 113, and an opening 114.

The receiving recess 111, which is formed so as to receive a part of the first pressing portion 410 and the wing 420 of the first stopper 400, has an approximately rectangular structure when viewed from above, and is brought into tight contact with a rear surface of the first pressing portion 410 and a part of the wing 420.

The horizontal support projection 112 supports a bottom surface of the wing 420 such that the first stopper 400 cannot moved downwards, and the pair of vertical support projections 113 blocks a part of a front surface of the wing 420 such that the first receiving portion 110 is not separated forwards.

The opening 114 is provided between the pair of vertical support projections 113, and the first pressing portion 410 protrudes forwards by a predetermined length through the opening 114, whereby the first pressing portion presses the pressure surface 320 of the module frame 300.

When describing a process of mounting the first stopper in the first receiving portion 110 in brief, a bolt fastening recess 330 configured to primarily fix the lower case 100 and the module frame 300 is provided under a side surface of the module frame 300, as shown in FIG. 6. Preferably, therefore, the module frame 300 is received in the lower case 100, the lower case 100 and the module frame 300 are fixed to each other using a bolt 340, and the first stopper 400 is mounted in the first receiving portion 110.

Of course, it is obvious that the first pressing portion 410 must have a length sufficient to securely press the pressure surface 320 of the module frame 300 when the first stopper 400 is mounted in the first receiving portion 110.

Meanwhile, the material for the first stopper 400 is not particularly restricted as long as the material exhibits predetermined elasticity. As an example, silicone may be used.

In addition, although no battery cell is shown in FIG. 6, a battery cell, more specifically a cylindrical battery cell, is received in a battery cell receiving recess 310 of the module frame 300.

The cylindrical battery cell generally includes an electrode assembly, an insulation member, a positive electrode lead wire, a cap assembly, and a battery can configured to receive the above components. The electrode assembly may be a jelly-roll type electrode assembly, which is configured to have a structure in which a long sheet type positive electrode and a long sheet type negative electrode are wound in the state in which a separator is interposed therebetween, a stacked type electrode assembly including unit cells, each of which is configured to have a structure in which a rectangular positive electrode and a rectangular negative electrode are stacked in the state in which a separator is interposed therebetween, a stacked and folded type electrode assembly, which is configured to have a structure in which unit cells are wound using a long separation film, or a laminated and stacked type electrode assembly, which is configured to have a structure in which unit cells are stacked in the state in which a separator is interposed therebetween and are then attached to each other.

In general, the positive electrode lead wire, which is attached to an upper end of the electrode assembly, is electrically connected to the cap assembly, and a negative electrode lead wire, which is attached to a lower end of the electrode assembly, is connected to a bottom of the battery can. Meanwhile, the insulation member may be located at an upper part of the electrode assembly, and the insulation member serves to insulate between the electrode assembly and the cap assembly.

The cap assembly is located at an upper part of the insulation member so as to be electrically connected to the positive electrode lead wire attached to the upper end of the electrode assembly, and is coupled to an open end of an upper part of the battery can to hermetically seal the electrode assembly received in the battery can.

Specifically, the cap assembly may be configured such that a current cut-off member, a current cut-off gasket, a safety vent, and a top cap are sequentially stacked from the bottom, and a crimping gasket and a welding holder may be located at outer edges of the safety vent and the top cap.

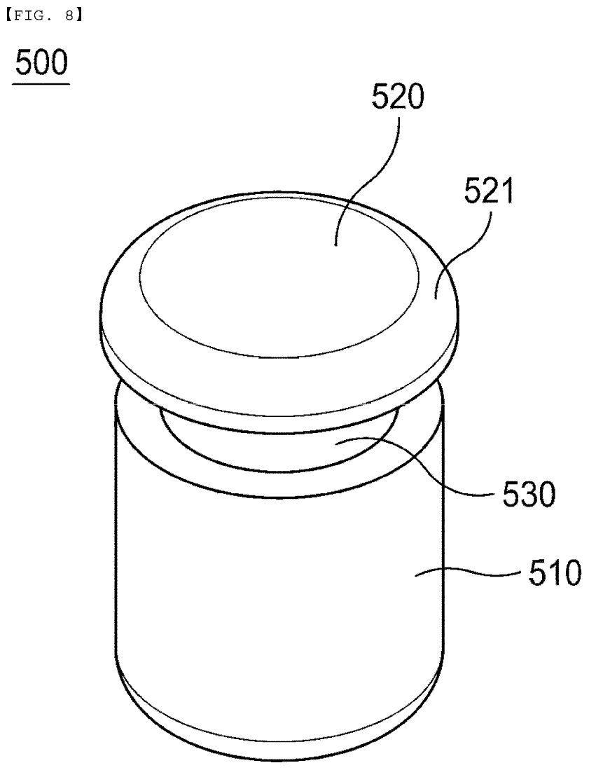

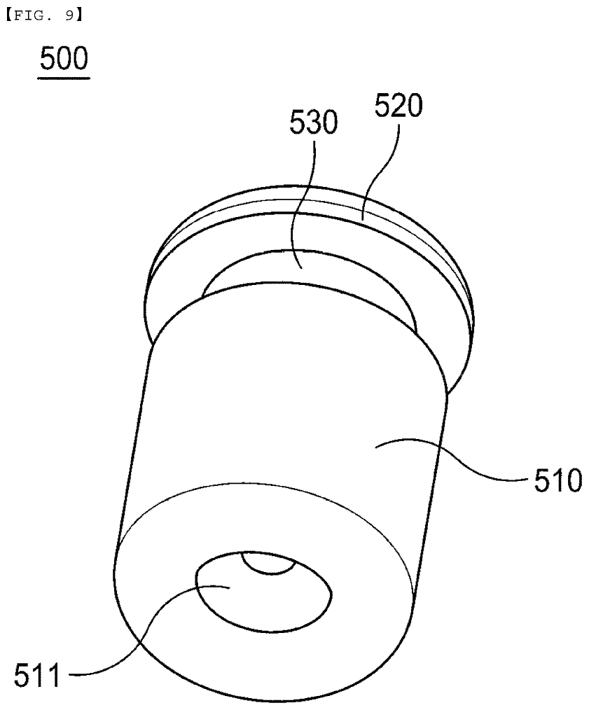

FIG. 7 is an enlarged view showing part B of FIG. 2, FIG. 8 is a front perspective view of the second stopper mounted in the battery pack according to the preferred embodiment of the present invention, and FIG. 9 is a bottom perspective view of the second stopper shown in FIG. 8.

The second stopper 500 will be described with reference to FIGS. 7 to 9.

The second stopper 500 includes a second columnar pressing portion 510, a head portion 520, and a connection portion 530.

Specifically, it is preferable for the second pressing portion 510 to have a cylindrical shape having a structure in which an end of the second pressing portion is somewhat curved while the second pressing portion has a predetermined diameter such that one side of the second pressing portion is brought into tight contact with the pressure surface 320 of the module frame 300 and the other side of the second pressing portion is brought into tight contact with an inner surface of the lower case 100.

Here, it is preferable for a depressed portion 511 dented inwards to be provided in one end of the second pressing portion 510, i.e. the part of the second pressing portion brought into tight contact with the pressure surface 320 of the module frame 300, so as to form a predetermined space. The reason for this is that it is possible to further attenuate impact by the empty space formed by the depressed portion 511.

The head portion 520 is located at an outer surface of the lower case 100, and an inner surface of the head portion 520 may be brought into tight contact with the outer surface of the lower case 100. The head portion may be formed in a circular shape having a predetermined thickness. The connection portion 530 is configured to connect the second pressing portion 510 and the head portion 520 to each other.

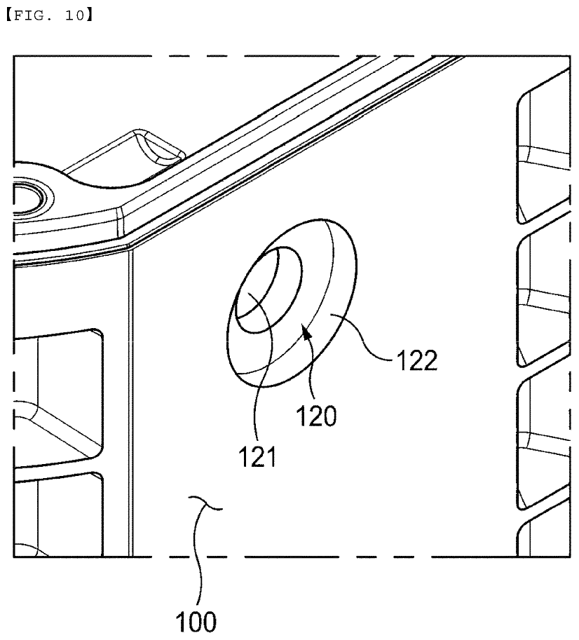

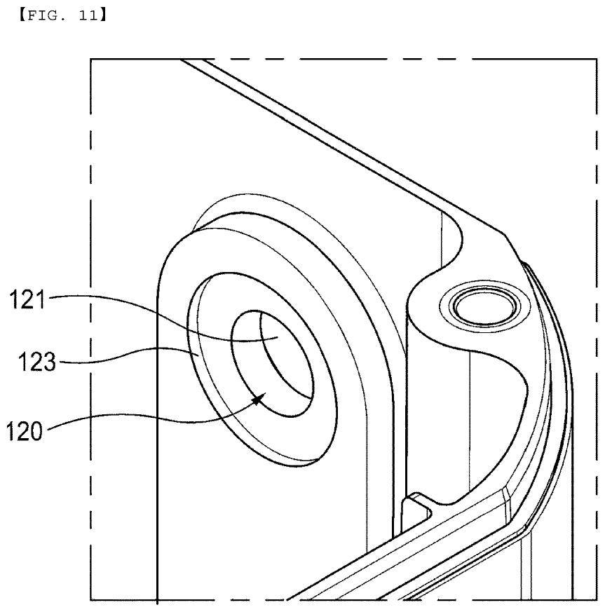

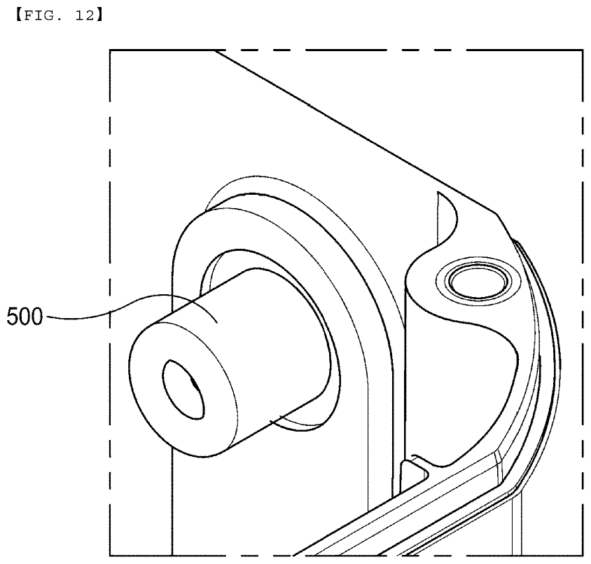

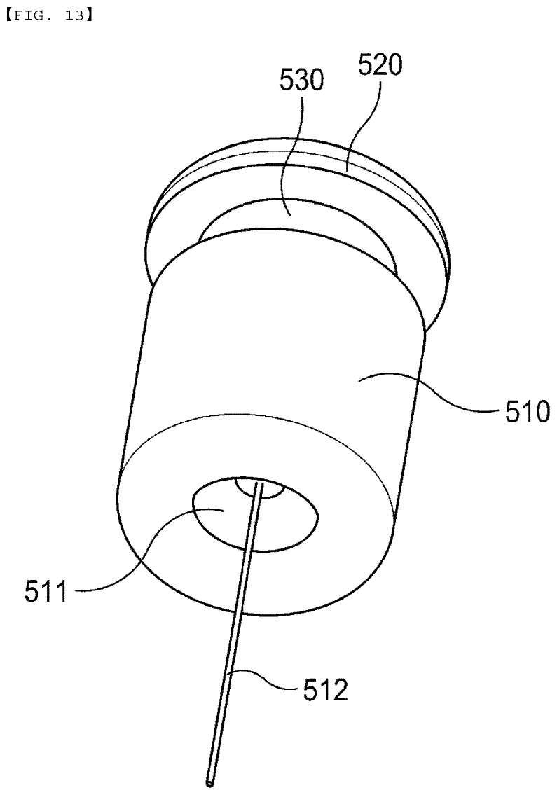

FIG. 10 is a perspective view of a second receiving portion in which the second stopper is mounted when viewed from the outside of the lower case, FIG. 11 is a perspective view of the second receiving portion in which the second stopper is mounted when viewed from the inside of the lower case, and FIG. 12 is a perspective view illustrating the state in which the second stopper is mounted to part B of FIG. 2.

The second receiving portion 120 configured to fix the second stopper 500 will be described with reference to FIGS. 10 to 12.

The second receiving portion 120 configured to fix the second stopper 500 is provided in the side wall of the lower case 100, i.e. the part of the lower case that faces the pressure surface 320 of the module frame 300.

Specifically, the second receiving portion 120 is constituted by a through-hole 121, an outer support projection 122, and an inner support projection 123.

First, the through-hole 121, which is the part at which the connection portion 530 is located, has a diameter slightly less than the diameter of the connection portion 530 such that the connection portion 530 can be securely supported and moisture cannot be introduced, and the head portion 520 is supported by the outer support projection 122.

Here, it is preferable for the outer support projection 122 to be slightly depressed inwardly of the side wall so as not to protrude out of the outer surface of the lower case 100 when the head portion 520 is located, and it is preferable for the outer support projection to have a diameter slightly greater than the diameter of the head portion 520 while having a circular shape corresponding to the outer shape of the head portion 520.

It is preferable for the inner support projection 123 to be slightly depressed so as to support a part of the second pressing portion 510, i.e. the vicinity of the connection portion 530, and it is more preferable for the inner support projection 123 to have a diameter slightly greater than the diameter of the connection portion 530 while having a circular shape identical to the outer shape of the connection portion 530.

Meanwhile, it is preferable that the diameter of the head portion 520 be the largest and that the diameter be smaller in the order of the second pressing portion 510 and the connection portion 530. The reason for this is that it is possible to easily mount the second stopper 500 in the second receiving portion 120 and to prevent the second stopper 500 from being easily separated from the second receiving portion.

It is obvious that the second pressing portion 510 must have a length sufficient to securely press the pressure surface 320 of the module frame 300 when the second stopper 500 is mounted in the second receiving portion 120.

When describing a process of mounting the second stopper in the second receiving portion 210, the module frame 300 is received in the lower case 100, the lower case 100 and the module frame 300 are fixed to each other using a bolt B, and the second stopper 500 is mounted in the second receiving portion 120, as described in connection with the first receiving portion 110.

Here, as a detailed assembly method of the second stopper 500, the second pressing portion 510 is pushed from the outer surface to the inner surface of the lower case 100 until the second pressing portion extends through the through-hole 121 and reaches the inner support projection 123.

Meanwhile, the second stopper 500 may be made of the same material as the first stopper 400.

FIG. 13 is a perspective view of the second stopper before being mounted in the battery pack when viewed from below. The second stopper 500 shown in FIG. 13 is identical in construction to the second stopper described above except that a grip bar 512 having one side connected to the depressed portion 511 and extending long while having a diameter less than the diameter of the through-hole 121 is further provided.

The grip bar 512 may assist in more convenient assembly of the second stopper 500. Specifically, the grip bar 512 is inserted through the through-hole 121, and the head portion 520 is pushed in while pulling the grip bar 512 with one hand. Of course, a part of the grip bar 512 may be cut after assembly of the second stopper 500 in the second receiving portion 120.

The battery pack may be used as a power source for various kinds of devices.

Although the specific details of the present invention have been described in detail, those skilled in the art will appreciate that the detailed description thereof discloses only preferred embodiments of the present invention and thus does not limit the scope of the present invention. Accordingly, those skilled in the art will appreciate that various changes and modifications are possible, without departing from the category and the technical idea of the present invention, and it will be obvious that such changes and modifications fall within the scope of the appended claims.

### DESCRIPTION OF REFERENCE NUMERALS

100: Lower case
110: First receiving portion
111: Receiving recess 112: Horizontal support projection
113: Vertical support projection 114: Opening
120: Second receiving portion
121: Through-hole 122: Outer support projection
123: Inner support projection
200: Upper case
300: Module frame
310: Battery cell receiving recess
320: Pressure surface
330: Bolt fastening recess
340: Bolt
400: First stopper
410: First pressing portion 411: First inclined surface
420: Wing
500: Second stopper
510: Second pressing portion
511: Depressed portion 512: Grip bar
520: Head portion 521: Second inclined surface
530: Connection portion

1. A battery pack comprising:
a lower case defining a first space having a predetermined size;
an upper case at an upper part of the lower case to be fastened to the lower case, the upper case defining a second space;
at least one module frame in the first space of the lower case and the second space of the upper case, the module frame defining a battery cell receiving recess; and
a battery cell in the battery cell receiving recess,
wherein an impact attenuation member configured to protect the module frame from external impact is disposed between an outer surface of the module frame and an inner surface of the lower case.

2. The battery pack according to claim 1, wherein the impact attenuation member includes a first stopper, and
wherein the first stopper comprises a first columnar pressing portion in contact with the outer surface of the module frame, and a pair of wings extending from opposite sides of the first pressing portion by a predetermined length.

3. The battery pack according to claim 2, wherein a first receiving portion configured to fix the first stopper is disposed in a side wall of the lower case, and
wherein the first receiving portion comprises a receiving recess configured to encompass a rear surface and a side surface of each wing such that the wing is seated and fixed, a horizontal support projection configured to support a bottom surface of the wing, a pair of vertical support projections configured to support a part of a front surface of the wing, and an opening between the pair of vertical support projections such that the first pressing portion protrudes forwards by a predetermined length.

4. The battery pack according to claim 2, wherein a front middle part of the first pressing portion protrudes farther forwards than front upper and lower parts of the first pressing portion in a height direction.

5. The battery pack according to claim 2, wherein a rear middle part of the first pressing portion protrudes farther rearwards than rear upper and lower parts of the first pressing portion in a height direction.

6. The battery pack according to claim 1, wherein the impact attenuation member includes a second stopper, and
wherein the second stopper comprises a second columnar pressing portion having one side in contact with the outer surface of the module frame and the other side in contact with the inner surface of the lower case, a head portion having one surface in contact with an outer surface of the lower case, and a connection portion configured to connect the second pressing portion and the head portion to each other.

7. The battery pack according to claim 6, wherein a second receiving portion configured to fix the second stopper is in a side wall of the lower case, and
wherein the second receiving portion comprises a through-hole configured to allow the connection portion to be disposed therein, an outer support projection at the outer surface of the lower case, the outer support projection being configured to support the head portion, and an inner support projection at the inner surface of the lower case, and the inner support projection being configured to support a part of the second pressing portion.

8. The battery pack according to claim 7, wherein each of the second pressing portion, the head portion, and the connection portion is cylindrical,
wherein a diameter of the connection portion is less than a diameter of each of the second pressing portion and the head portion, and
wherein a diameter of the through-hole is less than the diameter of each of the second pressing portion and the head portion.

9. The battery pack according to claim 8, wherein the diameter of the head portion is greater than the diameter of the second pressing portion.

10. The battery pack according to claim 7, wherein a depressed portion is disposed in one end of the second pressing portion to form a predetermined space.

11. A device having the battery pack according to claim 1 mounted therein.
